(19) United States
(12) Patent Application Publication
(10) Pub. No.: US 2008/0292814 A1
(43) Pub. Date: Nov. 27, 2008

(54) IMAGE FORMING ELEMENT AND FABRICATING METHOD THEREOF, AND IMAGE FORMING APPARATUS

(75) Inventors: Woon-bae KIM, Suwon-si (KR); Jong-oh Kwon, Suwon-si (KR); Seung-tae Choi, Osan-si (KR); Chang-youl Moon, Suwon-si (KR); Soon-cheol Kwon, Seoul (KR); Ki-hwan Kwon, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/014,975

(22) Filed: Jan. 16, 2008

(30) Foreign Application Priority Data
May 23, 2007 (KR) 2007-50366

(51) Int. Cl. C23C 26/00; G03G 15/00

(52) U.S. Cl. 427/595; 399/159; 430/56

(57) ABSTRACT

An image forming element, a fabricating method of the image forming element, and an image forming apparatus having the image forming element is provided. The image forming element includes a drum body, a driving circuit mounted within the drum body, a support plate which penetrates through the drum body longitudinally along the drum body, the support plate being coupled to the driving circuit, an insulating layer formed on at least one portion of an outer circumference of the drum body, a conductive polymer layer formed on the insulating layer, the conductive polymer layer including one or more conductive areas and one or more insulating areas, which are aligned in an alternating pattern, and a protective layer formed on the conductive polymer layer, wherein the conductive areas on the conductive polymer layer are electrically connected to the driving circuit. Therefore, an image forming element can be provided in which a conductive layer is formed so that conductive areas and insulating areas are patterned without stepped portions therebetween, simplifying the fabricating process and improving the precision.

### CROSS-REFERENCE TO RELATED APPLICATIONS

This application claims priority under 35 U.S.C. § 119 (a) from Korean Patent Application No. 10-2007-0050366, filed on May 23, 2007, in the Korean Intellectual Property Office, the disclosure of which is incorporated herein by reference in its entirety.

### BACKGROUND OF THE INVENTION

1. Field of the Invention

The present general inventive concept relates to an image forming element, a fabricating method thereof, and an image forming apparatus having the image forming element. More particularly, the present general inventive concept relates to an image forming element, a fabricating method thereof, and an image forming apparatus having the image forming element, in which a direct printing method is used.

2. Description of the Related Art

A direct printing method is a method in which a predetermined image forming element, such as an image drum, is directly applied with an image signal, a latent image is formed and developed, and a visible image is formed. Accordingly, in order to perform the direct printing process, there is no need for an exposing device or a charging device required in an electrophotographic process using a laser. Consequently, the direct type printing method does not require a light exposing device or a charging device, as is necessary for an electrophotographic method using a laser. The direct printing method has the advantages of stable processing and enables the size of an apparatus to be reduced, so this field has constantly been researched.

The operational principle of an image forming apparatus by a direct printing method is disclosed in U.S. Pat. No. 6,014,157.

An image drum described in the same patent includes a drum body, a plurality of ring electrodes, and a control unit.

The drum body has a substantially cylindrical configuration, and is made of a metallic material such as aluminum. A plurality of through holes of varying diameters are formed at an outer circumference of the drum body, so that each through hole corresponds to a ring electrode. The through holes are filled with conductive material.

The ring electrodes are formed along the outer circumference of the drum body, and at predetermined intervals from each other longitudinally along the drum body. Each ring electrode is insulated from the neighboring ring electrodes and also insulated from the drum body.

The ring electrodes are designed in various ways according to a desired degree of resolution, but the ring electrodes are arranged longitudinally along the drum body, generally at pitches approximately of 40 μm to achieve the resolution of 600 dpi.

The control unit is mounted inside the drum body, and has a terminal. The terminal and each ring electrode are electrically connected by zebra-strips and the conductive material. The control unit applies an appropriate voltage to each ring electrode according to image information, and as a result, a latent image is formed on the image drum.

It is possible to design an image forming element in a variety of ways in order to construct the ring electrodes according to a desired resolution. Conventionally, however, holes which are approximately 20 μm in width are required to be formed on the surface of the image forming element at the cycle of approximately 42.3 μm in order to construct the ring electrodes to achieve a resolution of approximately 600 dpi. Additionally, the through holes have to be formed on the wall of the drum body to electrically connect the ring electrodes with the control unit. Additionally, the through holes must be filled with conductive material. As a result, a conventional image forming element requires a complicated structure and fabricating process, which is accompanied with many fabricating works and high cost.

### SUMMARY OF THE INVENTION

The present general inventive concept provides an image forming element, in which an electrode is formed using a conductive polymer without stepped portions between conductive areas and insulating areas, so that the structure thereof can be simplified, the precision thereof can be improved and the size thereof can be reduced.

The present general inventive concept also provides a fabricating method of an image forming element, in which an electrode is formed using a conductive polymer without stepped portions between conductive areas and insulating areas, so that the fabricating process thereof can be simplified and the precision thereof can be improved at a low fabricating cost.

The present general inventive concept also provides an image forming apparatus having the above image forming element.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming element, which may include a drum body, a driving circuit mounted within the drum body, a support plate which penetrates through the drum body longitudinally along the drum body, the support plate coupled to the driving circuit, an insulating layer formed on at least one portion of an outer circumference of the drum body, a conductive polymer layer formed on the insulating layer, the conductive polymer layer including one or more conductive areas and one or more insulating areas, which are aligned in an alternating pattern and a protective layer formed on the conductive polymer layer, wherein the conductive areas on the conductive polymer layer are electrically connected to the driving circuit.

The conductive areas and insulating areas on the conductive polymer layer may be formed by emitting a light source to a conductive polymer and changing a conductivity of the conductive polymer.

The drum body may be made of a metallic material or a ceramic material. If the drum body is made of metallic material, aluminum or aluminum alloy may be used.

The insulating layer may have a thickness in a range of approximately 3 μm to approximately 10 μm.

The conductive polymer constituting the conductive polymer layer may include polyaniline (PANI) or a poly(3,4-ethylenedioxythiophene)/poly(styrenesulfonate) (PEDT/PSS) complex.

The conductive polymer may be PANI represented by the following Formula (I),

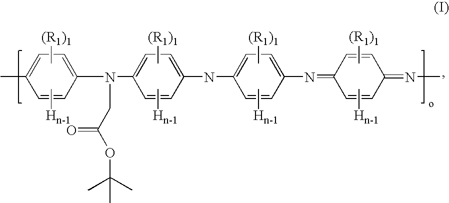

in which, n is an integer greater than or equal to 4; m is an integer of 1 to 5; l is an integer of 0 to 4; l+m is an integer of 5; R₁ is selected from the group consisting of alkyl, alkenyl, alkoxy, cycloalkyl, cycloalkenyl, cycloalkoxy, alkanoyl, alkylthio, aryloxy, alkylthioalkyl, alkylaryl, amino, alkylamino, dialkylamino, aryl, alkylsulfinyl, alkoxyalkyl, alkylsulfonyl, arylthio, arylsulfinyl, alkoxycarbonyl, arylsulfonyl, carboxylic acid, halogen and cyano; and the PANI includes mono-t-butoxy carbonyl group.

The conductive polymer may be a PEDT/PSS complex represented by the following Formula (III),

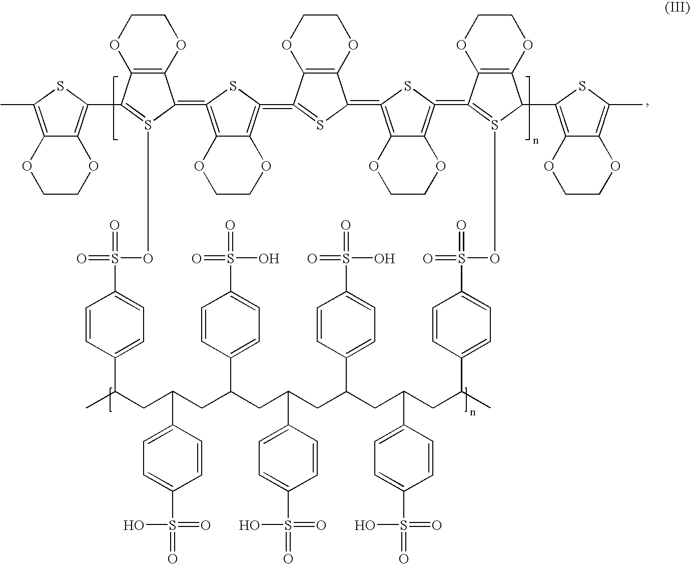

in which, n is a natural number greater than or equal to 1.

If the conductive polymer is PANI, the light source may be ultraviolet (UV) rays.

The conductive polymer layer may have a thickness in a range of approximately 10 μm to approximately 20 μm.

The insulating layer may be opened by a via process so that the support plate may be bonded to the conductive polymer layer in order to electrically connect the driving circuit to the conductive areas of the conductive polymer layer. The via process of the insulating layer may be performed by a laser or ion milling.

The via process for interconnection may also be performed by wet etching, dry etching such as reactive ion etching (RIE), or the like instead of a laser or ion milling.

If the conductive polymer is PANI, the conductive areas may have a conductivity in a range of approximately 30 S/cm to approximately 50 S/cm, and the insulating areas may have a conductivity in a range of approximately 10⁻⁵ S/cm to approximately 10⁻⁶ S/cm.

The protective layer may include silicon oxide (SiOₓ).

The protective layer may have a thickness in a range of approximately 0.05 μm to approximately 0.8 μm.

The foregoing and/or other aspects and utilities of the present general inventive concept may also be achieved by providing a method of fabricating an image forming element, which may include preparing a drum body, inserting a support plate including a driving circuit mounted within the drum body, coating an insulating layer on the drum body, coating a conductive polymer on the insulating layer, emitting a light source onto the conductive polymer in a predetermined pattern and changing conductivity of the conductive polymer, to form a conductive polymer layer including conductive areas, which are electrically connected to the driving circuit, and insulating areas and forming a protective layer on the conductive polymer layer.

The drum body may be made of a metallic material or a ceramic material. If the drum body is made of metallic material, aluminum or aluminum alloy may be used.

The coating the insulating layer may include depositing or precipitating a solution including an insulating material on the drum body to form an insulating layer.

The method may further include performing a via process by removing a portion of the insulating layer coated on the support plate, after forming the insulating layer and before coating the conductive polymer on the insulating layer, in order to electrically connect the driving circuit to the conductive areas of the conductive polymer layer. The removing may include performing a via process by a laser or ion milling.

The via process for interconnection may also be performed by wet etching, dry etching such as reactive ion etching (RIE), or the like instead of a laser or ion milling.

The insulating layer may have a thickness in a range of approximately 3 μm to approximately 10 μm.

The coating the conductive polymer on the insulating layer may include precipitating the drum body in a solution including a conductive polymer, or spraying the solution including a conductive polymer onto the insulating layer, in order to coat the insulating layer with the conductive polymer.

The conductive polymer may be polyaniline (PANI) represented by the following Formula (I),

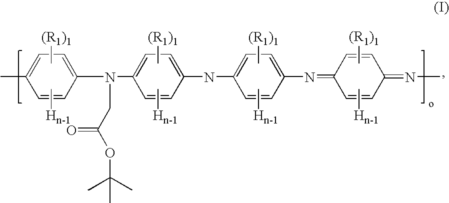

in which, n is an integer greater than or equal to 4, m is an integer of 1 to 5, l is an integer of 0 to 4, l+m is an integer of 5, R₁ is selected from the group consisting of alkyl, alkenyl, alkoxy, cycloalkyl, cycloalkenyl, cycloalkoxy, alkanoyl, alkylthio, aryloxy, alkylthioalkyl, alkylaryl, amino, alkylamino, dialkylamino, aryl, alkylsulfinyl, alkoxyalkyl, alkylsulfonyl, arylthio, arylsulfinyl, alkoxycarbonyl, arylsulfonyl, carboxylic acid, halogen and cyano, and the PANI includes mono-t-butoxy carbonyl group.

If the conductive polymer is PANI, the coating the conductive polymer may be performed using PANI together with a photoacid generator (PAG).

The light source emitted onto PANI represented by Formula (I) may be ultraviolet (UV) rays.

The conductive polymer may be a poly(3,4-ethylened ioxythiophene)/poly(styrenesulfonate) (P EDT/PSS) complex represented by the following Formula (III),

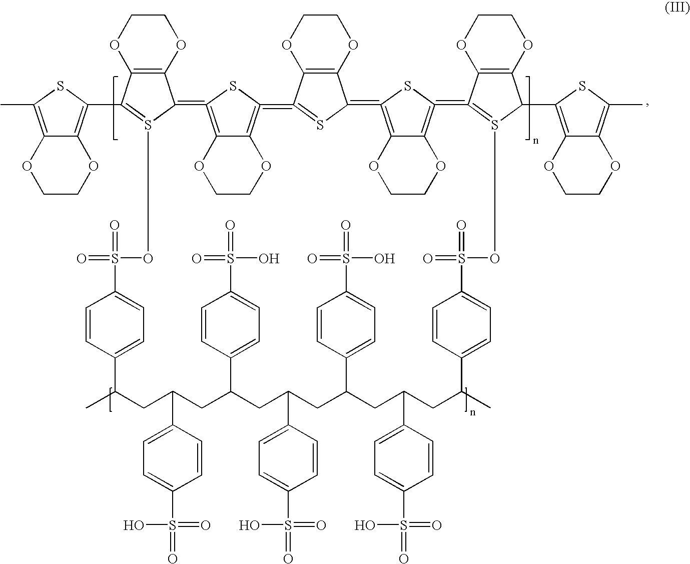

in which, n is a natural number greater than or equal to 1. The light source may be UV rays.

The conductive polymer layer may have a thickness in a range of approximately 10 μm to approximately 20 μm.

The protective layer may be formed by coating the conductive polymer layer with silicon oxide (SiOₓ).

The protective layer may be formed by a sputtering process or a chemical vapor deposition (CVD) process.

The foregoing and/or other aspects and utilities of the present general inventive concept may also be achieved by providing an image forming apparatus, which may include a toner feed unit, an image forming element to which a toner from the toner feed unit is absorbed, an image developing unit to develop an image on the image forming element, by separating at least a portion of the absorbed toner from the image forming element, and an image transfer unit to transfer the developed image from the image forming element onto a printing medium.

### BRIEF DESCRIPTION OF THE DRAWINGS

The above aspects and utilities of the present general inventive concept will be more apparent by describing certain embodiments of the present general inventive concept with reference to the accompanying drawings, in which:

FIG. 1 is a schematic view illustrating an image forming element prior to forming a protective layer, according to an exemplary embodiment of the present general inventive concept;

FIG. 2 is a schematic, cross-sectional view illustrating an image forming element according to another exemplary embodiment of the present general inventive concept;

FIGS. 3A to 3D are schematic views illustrating processes to fabricate an image forming element using polyaniline (PANI) as a conductive polymer, according to an exemplary embodiment of the present general inventive concept;

FIGS. 4A to 4D are schematic views illustrating processes to fabricate an image forming element using a poly(3,4-ethylenedioxythiophene)/poly(styrenesulfonate) (PEDT/PSS) complex as a conductive polymer, according to another exemplary embodiment of the present general inventive concept; and

FIG. 5 is a flowchart illustrating a method to fabricate an image forming element, according to an exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

FIG. 1 is a schematic view illustrating an image forming element according to an exemplary embodiment of the present general inventive concept. In FIG. 1, the image forming element according to an exemplary embodiment of the present general inventive concept includes a drum body 100, a support plate 300, a plurality of band-shaped conductive areas 501 formed along an outer circumference of the drum body 100, and a plurality of insulating areas 502 arranged between the conductive areas 501.

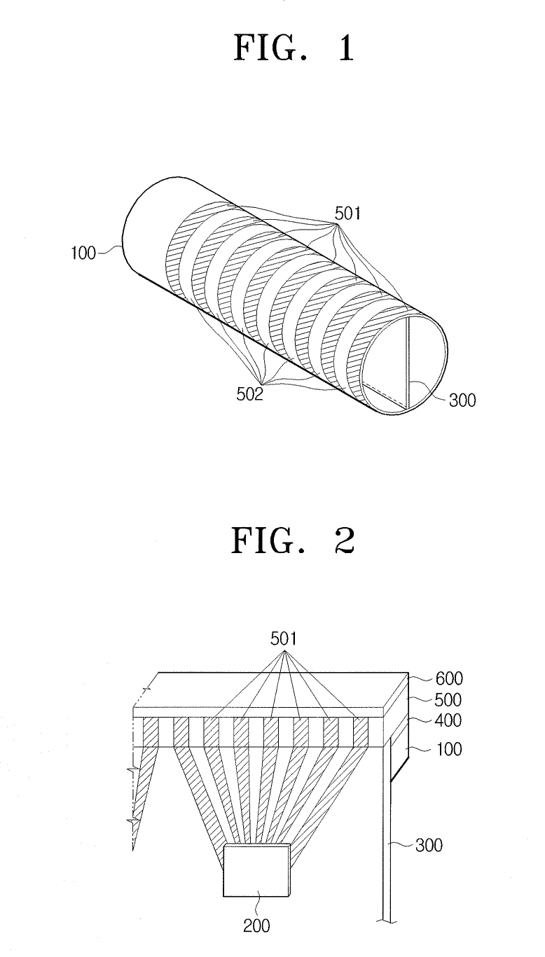

FIG. 2 is a schematic, cross-sectional view illustrating an image forming element according to another exemplary embodiment of the present general inventive concept. In FIG. 2, an insulating layer 400 formed on the drum body 100 enables a conductive polymer layer 500 and the drum body 100 to be insulated from each other. The conductive areas 501 of the conductive polymer layer 500 are electrically connected to a driving circuit 200 mounted on the support plate 300. Each conductive area 501 of the conductive polymer layer 500 is separated from each other by the insulating areas 502, and also is electrically separated from the drum body 100 by the insulating layer 400. A protective layer 600 is formed on the conductive polymer layer 500.

As illustrated in FIGS. 1 and 2, the plurality of band-shaped conductive areas 501 are circumferentially formed at regular intervals and have a predetermined thickness. Additionally, the conductive areas 501 and the insulating areas 502 are formed without stepped portions therebetween.

The drum body may be made of metallic material or ceramic material. The material constituting the drum body can be selected taking into consideration the convenience of molding and the chemical and physical environments of an electronic device to be used, but the present general inventive concept is not limited to such a configuration.

The drum body can be made of metallic material, such as aluminum or an aluminum alloy, which is light in weight and can be easily molded at low cost, taking into consideration the environment available for the image forming element.

Referring to FIG. 1, the drum body 100 may be provided in the form of an integral hollow cylinder, but various alternative configurations are possible. For example, although not illustrated in the drawings, a drum body including a driving circuit mounted therein such that the driving circuit is electrically connected to conductive electrodes formed on the outer circumference of the drum body can be used regardless of a shape of the drum body, even if the drum body has a cylindrical shape or a polygonal shape.

The insulating layer 400 formed on the drum body 100 can have a thickness of approximately 3 μm to approximately 10 μm. If the thickness of the insulating layer 400 is less than approximately 3 μm, insulating properties between the drum body 100 and the conductive polymer layer 500 can be reduced, and if the thickness of the insulating layer 400 is greater than approximately 10 μm, it may be difficult to form an insulating layer and to reduce a size of the image forming element.

The insulating layer 400 may be opened by a via process so that the support plate 300 may be directly brought into contact with the conductive polymer layer 500, in order to electrically connect the driving circuit 200 to the conductive areas 501 of the conductive polymer layer 500. As illustrated in FIG. 2, an electrode of the driving circuit 200 is connected to the conductive areas 501, and the insulating layer 400 is not formed on the support plate 300. Laser or ion milling may be used to form a channel through the insulating layer 400.

A light source may be emitted to a conductive polymer to change conductivity of the conductive polymer, so that the conductive polymer layer 500 can be divided into the conductive areas 501 and the insulating areas 502.

Any polymer that can be divided into conductive material and insulating material as a result of a change in conductivity can be used as a conductive polymer usable in the above exemplary embodiment.

Polyaniline (PANI) or poly(3,4-ethylene dioxythiophene)/poly(styrenesulfonate) (PEDT/PSS) may be used as a conductive polymer usable in the above exemplary embodiment, but the present general inventive concept is not limited thereto.

If PANI is used as the conductive polymer usable in the above exemplary embodiment, PANI represented by the following Formula (I) may be used

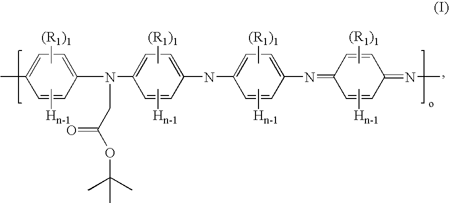

in which, n is an integer greater than or equal to 4; m is an integer of 1 to 5; l is an integer of 0 to 4; l+m is an integer of 5; R₁ is selected from the group consisting of alkyl, alkenyl, alkoxy, cycloalkyl, cycloalkenyl, cycloalkoxy, alkanoyl, alkylthio, aryloxy, alkylthioalkyl, alkylaryl, amino, alkylamino, dialkylamino, aryl, alkylsulfinyl, alkoxyalkyl, alkylsulfonyl, arylthio, arylsulfinyl, alkoxycarbonyl, arylsulfonyl, carboxylic acid, halogen and cyano and the PANI comprises mono-t-butoxy carbonyl group.

PANI is a conjugated conductive polymer having theorically high electrical conductivity in which single and double bonds are conjugated using carbon center with sp2 hybrid orbitals.

PANI having the mono-t-butoxycarbonyl group used in the above exemplary embodiment is soluble in a common solvent, and may exhibit insulating properties due to its low conductivity.

When PANI represented by the Formula (I) is synthesized with a photoacid generator (PAG) and a synthetic product is then exposed to ultraviolet (UV) rays, PANI emeraldine salts may be formed while the mono-t-butoxycarbonyl group is separated from PANI. When the emeraldine salts are formed, the conductivity of PANI can be increased so that the UV-exposed area can be changed to a conductive region.

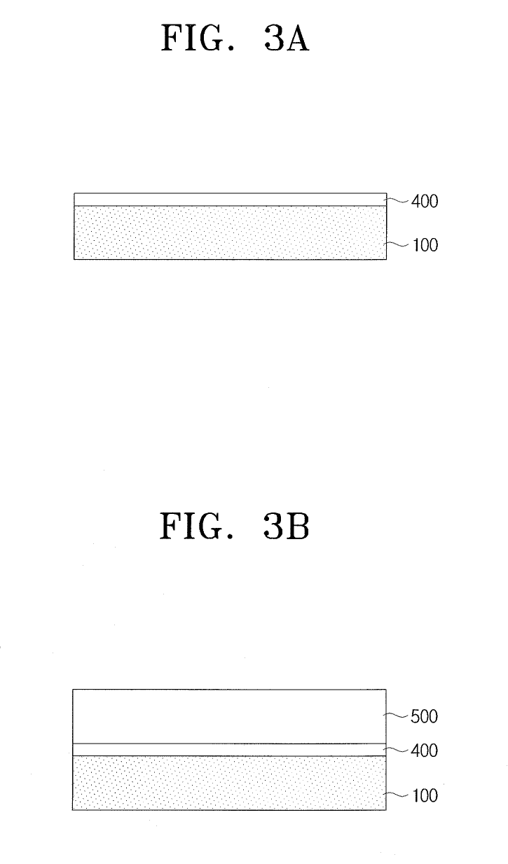

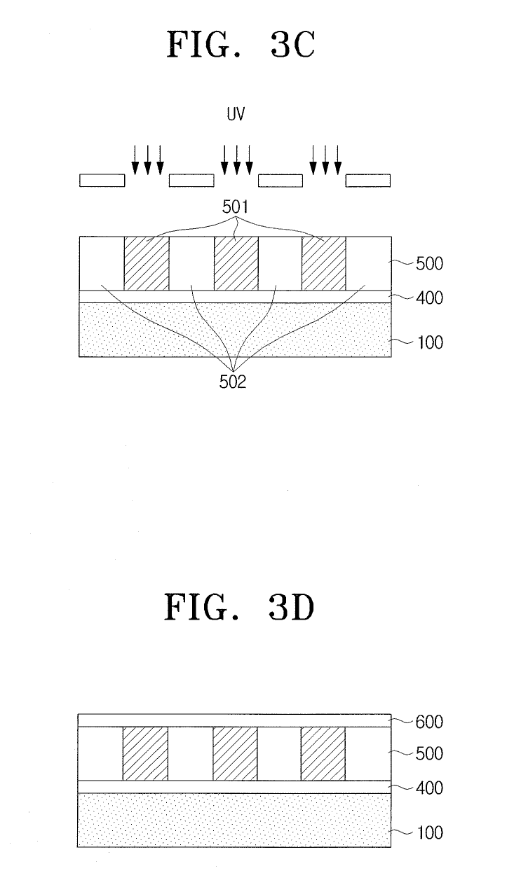

A process to fabricate an image forming element using PANI as a conductive polymer is schematically illustrated in FIGS. 3A to 3D.

FIG. 3A illustrates a section of the image forming element in which the insulating layer 400 is formed on the drum body 100, and FIG. 3B illustrates a section of the image forming element in which the insulating layer 400 is coated with PANI to form the conductive polymer layer 500. As illustrated in FIG. 3C, the conductive polymer layer 500 is patterned by UV exposure in a predetermined pattern so that UV-exposed areas are converted to the conductive areas 501 and unexposed areas are converted to the insulating areas 502.

When the insulating layer 400 is coated with PANI, the PAG may be used together with PANI.

The PAG usable in this exemplary embodiment may be independently selected from the group consisting of phthalimidotrifluoromethane sulfonate, dinitrobenzyltosylate, n-decyldisulfone, naphthylimidotrifluoromethane sulfonate, diphenyl iodide hexafluorophosphate, diphenyl iodide hexafluoroarsenate, diphenyl iodide hexafluoroantimonate, diphenyl p-methoxyphenyl triflate, diphenyl p-toluenyl triflate, diphenyl p-isobutylphenyl triflate, triphenylsulfonium hexafluoroarsenate, triphenylsulfonium hexafluoroantimonate, triphenylsulfonium triflate and dibutylnaphtylsulfonium triflate, or a mixture thereof, but the present general inventive concept is not limited thereto.

The following Formula (II) represents the PANI emeraldine salts after UV exposure.

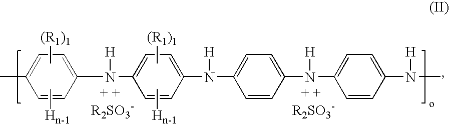

in which, R₂ may be tosyl or camphor, or may be another substituent according to the type of PAG to be used.

PANI of the insulating areas has a conductivity of approximately 10⁻⁵ S/cm to approximately 10⁻⁶ S/cm in order to be used in the process to fabricate the image forming element. Insulating areas having conductivity within the above range are required in order to prevent current leakage or short circuits from occurring. However, the conductivity of insulating areas is provided taking into consideration the chemical and physical environment of the image forming element to be used. Additionally, PANI of the conductive areas has a conductivity of approximately 30 S/cm to approximately 50 S/cm. If the conductivity of the conductive areas is within the above range, nonconductivity may be less than 0.3 Ωcm, so PANI of the conductive areas can be used as an electrically conductive wire.

After the patterning operation described above, it is not necessary to perform etching or additional deposition processes to form a surface having no stepped portions between the conductive areas and the insulating areas.

After the conductive polymer layer 500 is formed, the protective layer 600 is formed on the conductive polymer layer 500 as illustrated in FIG. 3D.

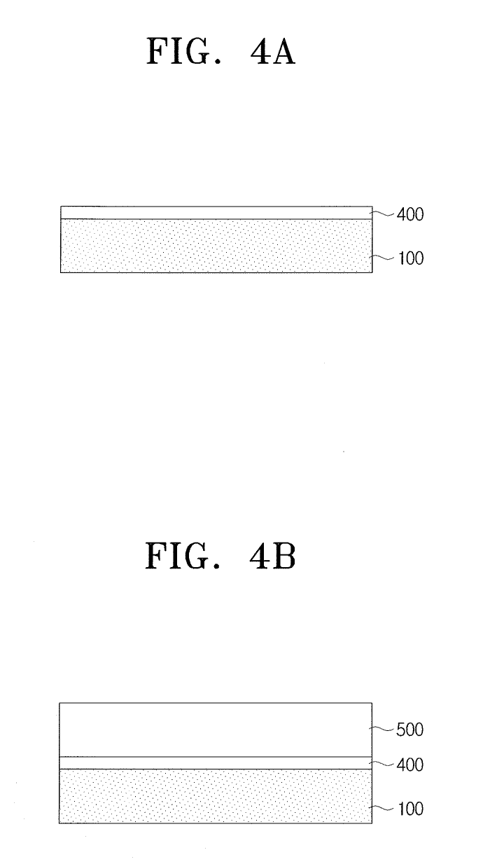

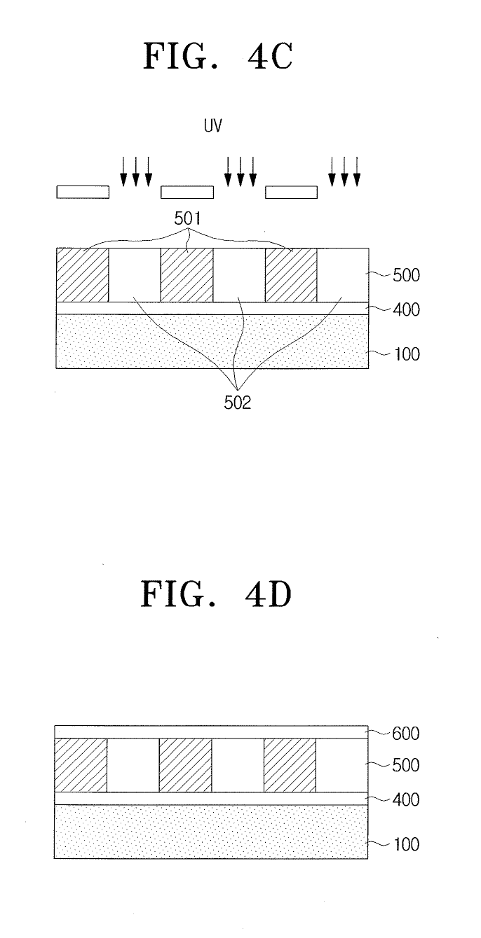

A process to fabricate an image forming element using a PEDT/PSS complex as a conductive polymer is schematically illustrated in FIGS. 4A to 4D.

FIG. 4A illustrates a section of the image forming element in which the insulating layer 400 is formed on the drum body 100, and FIG. 4B illustrates a section of the image forming element in which the insulating layer 400 is coated with the PEDT/PSS complex to form the conductive polymer layer 500. As illustrated in FIG. 4C, the conductive polymer layer 500 is patterned by UV exposure in a predetermined pattern such that unexposed areas are converted to the conductive areas 501 and UV-exposed areas are converted to the insulating areas 502.

PEDT/PSS is referred to as PEDOT/PSS, and is a polymer complex exhibiting conductivity. PEDT/PSS may be divided into insulating portions and conductive portions by the exposing operation. The weight ratio of PEDT to PSS may be approximately 1:2.5, and so PEDT/PTT may be used as a complex.

PEDT/PSS may be represented by the following Formula (III).

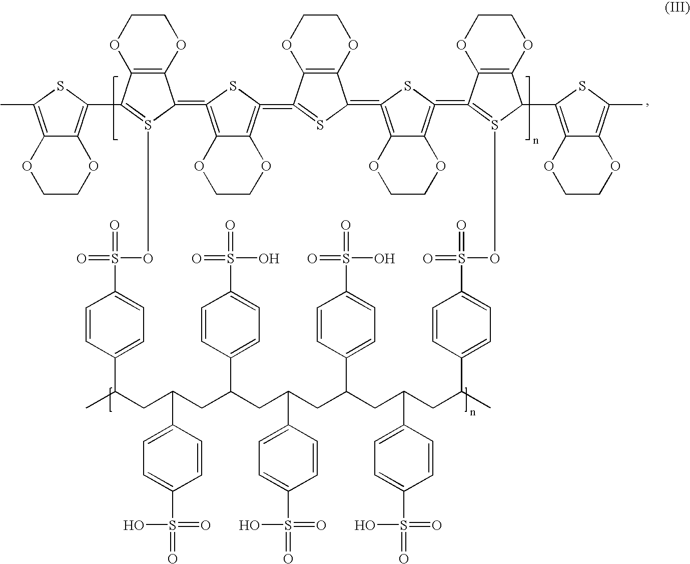

in which, n is a natural number greater than or equal to 1.

BAYTRON®, manufactured by H. C. Starck, and in particular BAYTRON® PH 500, is a commercially available form of PEDT/PSS.

Exposed areas of PEDT/PSS may be changed to insulating areas and unexposed areas thereof may be changed to conductive areas, differently from PANI.

Referring to FIG. 4D, after the conductive polymer layer 500 is patterned by light exposure so that the conductive areas 501 and the insulating areas 502 are formed, as described above, the protective layer 600 may be formed on the conductive polymer layer 500.

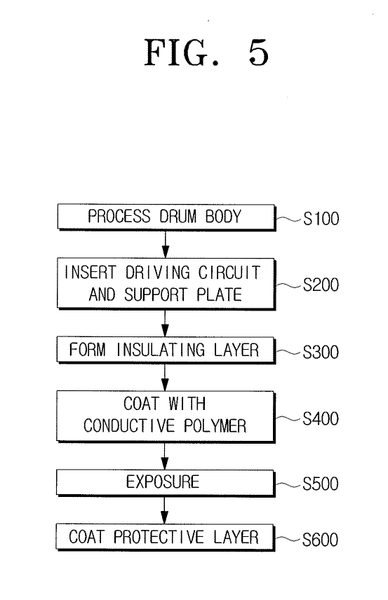

A method to fabricate an image forming element according to an exemplary embodiment of the present general inventive concept will be explained below with reference to FIG. 5.

First, a drum body is processed in operation S100. As described above, the drum body may be made of metallic material or ceramic material. A driving circuit is prepared to drive the image forming element, and a support plate including the driving circuit is fabricated and is then inserted into the drum body in operation S200. In order to insert the support plate into the drum body, a cavity is formed on the drum body into which the support plate can be inserted and bonded together with using material such as epoxy. In this situation, the drum body may be molded into a predetermined shape, and the support plate may then be inserted into the cavity of the drum body, or alternatively, the support plate may be bonded to one side of the drum body, and the drum body may then be molded into a predetermined shape so that the support plate may be inserted therein.

Subsequently, an insulating material may be deposited on the outer circumference of the drum body, or the drum body may be precipitated in the insulating material, so that an insulating layer can be formed on the outer circumference of the drum body in operation S300. After the insulating layer is formed, the insulating layer may be processed so that the image forming element can have a smooth surface. In this situation, the insulating material deposited on the support plate may be via-processed by a laser or ion milling, so that the insulating layer cannot be formed on the support plate exposed on the outer circumference of the drum body through the cavity of the drum body.

In order to form a conductive polymer layer on the insulating layer, the drum body may be immersed in a conductive polymer, or the insulating layer may be coated with a conductive polymer by a spraying process in operation S400.

Subsequently, the formed conductive polymer layer may be exposed to a predetermined light source in operation S500, so that conductive areas and insulating areas may be patterned. Patterning may be performed differently according to the properties of the conductive polymer. Additionally, the type and intensity of the light source used for exposure and the period of time required for exposure may be determined based on the properties of the conductive polymer.

The conductive polymer layer may have a thickness of approximately 10 μm to approximately 20 μm. If the thickness of the conductive polymer layer is less than the above range, resistance may increase, making it possible for errors to arise when the conductive areas receive and process signals. If the thickness of the conductive polymer layer is greater than the above range, a level of exposure may vary according to a height of the image forming element during light exposure after coating with polymer, so the conductivity may be non-uniform even in the same areas.

After the conductive polymer layer is formed and exposed to the light, a protective layer may be coated on the conductive polymer layer in operation S600.

The protective layer may be coated with silicon oxide (SiOₓ) by a sputtering process or by a chemical vapor deposition (CVD) process.

The protective layer may have a thickness of approximately 0.05 μm to approximately 0.8 μm. The protective layer can have a thickness greater than approximately 0.05 μm in order to protect the conductive polymer layer, but the protective layer is formed as thinly as possible in order to ensure the electrostatic force based on the electrical field, and thus, the thickness of the protective layer may be equal to or less than approximately 0.8 μm.

Although not illustrated in the drawings, the image forming apparatus according to the exemplary embodiment of the present general inventive concept can include a toner feed unit, an image forming element configured described above, an image developing unit, and an image transfer unit.

While the image forming element and the image forming apparatus including the image forming element was explained above in various exemplary embodiments of the present general inventive concept, the method to fabricate an image forming element using the conductive polymer according to the exemplary embodiments of the present general inventive concept is applicable to any field, such as flexible displays, in which a plastic substrate is used, as well as to microelectric devices.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image forming element, comprising:
a drum body;
a driving circuit mounted within the drum body;
a support plate which penetrates through the drum body longitudinally along the drum body, the support plate being coupled to the driving circuit;
an insulating layer formed on at least one portion of an outer circumference of the drum body;
a conductive polymer layer formed on the insulating layer, the conductive polymer layer including one or more conductive areas and one or more insulating areas, which are aligned in an alternating pattern; and
a protective layer formed on the conductive polymer layer,
wherein the conductive areas on the conductive polymer layer are electrically connected to the driving circuit.

2. The image forming element of claim 1, wherein the conductive areas and insulating areas on the conductive polymer layer are formed by emitting a light source to a conductive polymer and changing a conductivity of the conductive polymer.

3. The image forming element of claim 1, wherein the drum body is made of a metallic material or a ceramic material.

4. The image forming element of claim 3, wherein the drum body is made of metallic material comprising:
aluminum or aluminum alloy.

5. The image forming element of claim 1, wherein the insulating layer has a thickness in a range of approximately 3 μm to approximately 10 μm.

6. The image forming element of claim 2, wherein the conductive polymer constituting the conductive polymer layer comprises:
polyaniline (PANI) or a poly(3,4-ethylenedioxythiophene)/poly(styrenesulfonate) (PEDT/PSS) complex.

7. The image forming element of claim 6, wherein the conductive polymer is PANI represented by the following Formula (I), 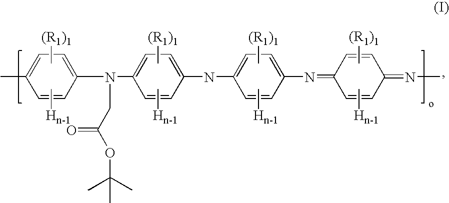
in which, n is an integer greater than or equal to 4; m is an integer of 1 to 5; l is an integer of 0 to 4; l+m is an integer of 5; R₁ is selected from the group consisting of alkyl, alkenyl, alkoxy, cycloalkyl, cycloalkenyl, cycloalkoxy, alkanoyl, alkylthio, aryloxy, alkylthioalkyl, alkylaryl, amino, alkylamino, dialkylamino, aryl, alkylsulfinyl, alkoxyalkyl, alkylsulfonyl, arylthio, arylsulfinyl, alkoxycarbonyl, arylsulfonyl, carboxylic acid, halogen and cyano and the PANI comprises mono-t-butoxy carbonyl group.

8. The image forming element of claim 6, wherein the conductive polymer is a PEDT/PSS complex represented by the following Formula (III), 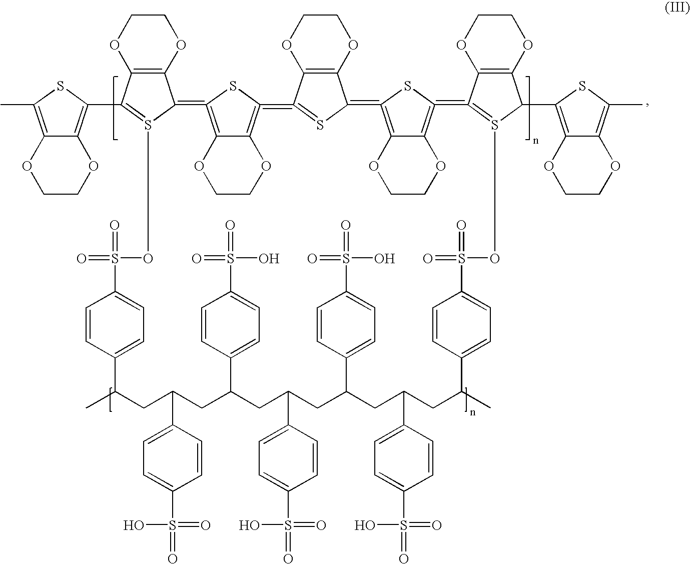
in which, n is a natural number greater than or equal to 1.

9. The image forming element of claim 7, wherein the light source comprises:
ultraviolet (UV) rays.

10. The image forming element of claim 1, wherein the conductive polymer layer has a thickness in a range of approximately 10 μm to approximately 20 μm.

11. The image forming element of claim 1, wherein the insulating layer is opened by a via process so that the support plate is bonded to the conductive polymer layer in order to electrically connect the driving circuit to the conductive areas of the conductive polymer layer.

12. The image forming element of claim 11, wherein the via process of the insulating layer is performed by a laser or ion milling.

13. The image forming element of claim 7, wherein the conductive areas have a conductivity in a range of approximately 30 S/cm to approximately 50 S/cm, and the insulating areas have a conductivity in a range of approximately 10⁻⁵ S/cm to approximately 10⁻⁶ S/cm.

14. The image forming element of claim 1, wherein the protective layer comprises:
silicon oxide (SiOₓ).

15. The image forming element of claim 1, wherein the protective layer has a thickness in a range of approximately 0.05 μm to approximately 0.8 μm.

16. A method to fabricate an image forming element, the method comprising:
preparing a drum body;
inserting a support plate including a driving circuit mounted within the drum body;
coating an insulating layer on the drum body;
coating a conductive polymer on the insulating layer;
emitting a light source onto the conductive polymer in a predetermined pattern and changing a conductivity of the conductive polymer, to form a conductive polymer layer including conductive areas, which are electrically connected to the driving circuit, and insulating areas; and
forming a protective layer on the conductive polymer layer.

17. The method of claim 16, wherein the drum body is made of a metallic material or a ceramic material.

18. The method of claim 17, wherein the metallic material comprises:
aluminum or aluminum alloy.

19. The method of claim 16, wherein the coating the insulating layer comprises:
depositing or precipitating a solution including an insulating material on the drum body to form an insulating layer.

20. The method of claim 16, further comprising:
performing a via process by removing a portion of the insulating layer coated on the support plate, after forming the insulating layer and before coating the conductive polymer on the insulating layer, in order to electrically connect the driving circuit to the conductive areas of the conductive polymer layer.

21. The method of claim 19, wherein the removing comprises:
performing a via process by a laser or ion milling.

22. The method of claim 16, wherein the insulating layer has a thickness in a range of approximately 3 μm to approximately 10 μm.

23. The method of claim 16, wherein the coating the conductive polymer on the insulating layer comprises:
precipitating the drum body in a solution including a conductive polymer, or spraying the solution including a conductive polymer onto the insulating layer, in order to coat the insulating layer with the conductive polymer.

24. The method of claim 16, wherein the conductive polymer is PANI represented by the following Formula (I), 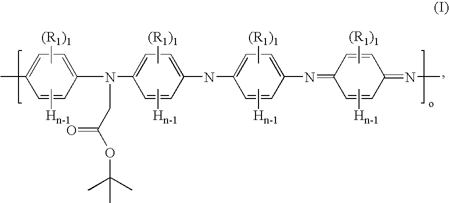
in which, n is an integer greater than or equal to 4; m is an integer of 1 to 5; l is an integer of 0 to 4; l+m is an integer of 5; R₁ is selected from the group consisting of alkyl, alkenyl, alkoxy, cycloalkyl, cycloalkenyl, cycloalkoxy, alkanoyl, alkylthio, aryloxy, alkylthioalkyl, alkylaryl, amino, alkylamino, dialkylamino, aryl, alkylsulfinyl, alkoxyalkyl, alkylsulfonyl, arylthio, arylsulfinyl, alkoxycarbonyl, arylsulfonyl, carboxylic acid, halogen and cyano and the PANI comprises mono-t-butoxy carbonyl group.

25. The method of claim 24, wherein the coating the conductive polymer is performed using polyaniline (PANI) together with a photoacid generator (PAG) if the conductive polymer is PANI.

26. The method of claim 24, wherein the light source emitted onto PANI represented by Formula (I) comprises:
ultraviolet (UV) rays.

27. The method of claim 16, wherein the conductive polymer comprises:
a poly(3,4-ethylenedioxythiophene)/poly(styrenesulfonate) (PEDT/PSS) complex represented by the following Formula (III), 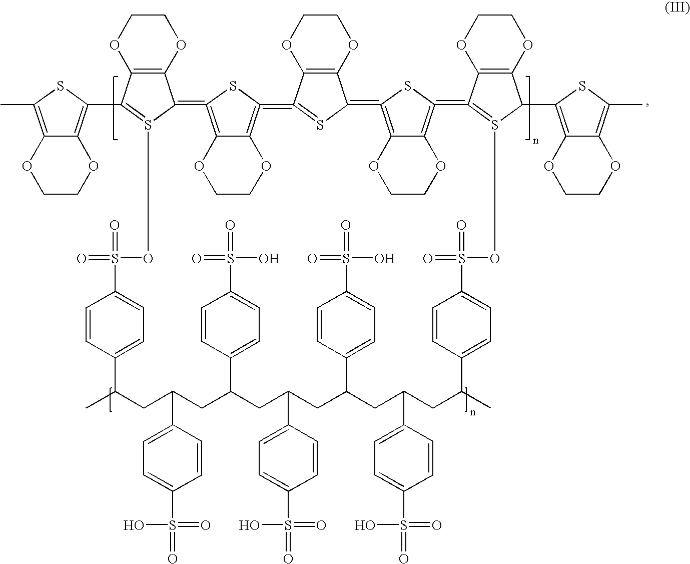
in which, n is a natural number greater than or equal to 1,
wherein the light source emitted to the PEDT/PSS complex comprises UV rays.

28. The method of claim 16, wherein the conductive polymer layer has a thickness in a range of approximately 10 μm to approximately 20 μm.

29. The method of claim 16, wherein the protective layer is formed by coating the conductive polymer layer with silicon oxide (SiOₓ).

30. The method of claim 16, wherein the protective layer is formed by a sputtering process or a chemical vapor deposition (CVD) process.

31. An image forming apparatus, comprising:
a toner feed unit;
an image forming element onto which a toner from the toner feed unit is absorbed;
an image developing unit to develop an image on the image forming element, by separating at least a portion of the absorbed toner from the image forming element; and
an image transfer unit to transfer the developed image from the image forming element onto a printing medium, wherein
the image forming element comprises:
a drum body;
a driving circuit mounted within the drum body;
a support plate which penetrates through the drum body longitudinally along the drum body, the support plate coupled to the driving circuit;
an insulating layer formed on at least one portion of an outer circumference of the drum body;
a conductive polymer layer formed on the insulating layer, the conductive polymer layer including one or more conductive areas and one or more insulating areas, which are aligned in an alternating pattern; and
a protective layer formed on the conductive polymer layer,
wherein the conductive areas on the conductive polymer layer are electrically connected to the driving circuit.
